(19) United States
(12) Patent Application Publication
(10) Pub. No.: US 2026/0210882 A1
(43) Pub. Date: Jul. 23, 2026

(54) Apparatus for Inspecting Electrode Current Collector, Apparatus for Manufacturing Electrode, and Method for Manufacturing Electrode

(71) Applicant: LG Energy Solution, Ltd., Seoul (KR)

(72) Inventors: Seon Hyeong Na, Daejeon (KR); Ki Hoon Paeng, Daejeon (KR)

(73) Assignee: LG Energy Solution, Ltd., Seoul (KR)

(21) Appl. No.: 19/569,004

(22) Filed: Mar. 17, 2026

Related U.S. Application Data
(63) Continuation of application No. PCT/KR2024/015132, filed on Oct. 4, 2024.

(30) Foreign Application Priority Data
Oct. 6, 2023 (KR) 10-2023-0133820

(51) Int. Cl. G01N 23/20091; H01M 4/02; H01M 4/04

(52) U.S. Cl. CPC G01N 23/20091; H01M 4/0435; G01N 2223/0563; G01N 2223/1016; G01N 2223/642; H01M 2004/021; H01M 2004/028

(57) ABSTRACT

Aspects of the disclosure are directed to inspecting an electrode current collector and manufacturing an electrode with increased accuracy in evaluation of mechanical properties of the electrode current collector through non-destructive inspection. More specifically, through x-ray diffraction (XRD) analysis in selecting an electrode current collector, aspects of the disclosure allow for monitoring and/or screening mechanical properties of an electrode current collector with higher accuracy. Further, if evaluating the mechanical properties of an electrode current collector are included in the manufacturing process for the electrode, degradation in strength of the electrode current collector being heat-treated can be predicted and/or prevented, thereby resolving defects which may occur during electrode manufacturing.

### CROSS-REFERENCE TO RELATED APPLICATIONS

This application is a continuation of International Application No. PCT/KR2024/015132, filed on Oct. 4, 2024, which claims priority to Korean Patent Application No. 10-2023-0133820, filed on Oct. 6, 2023, all of which is incorporated herein by reference.

### BACKGROUND

As the technology development and demand for electric vehicles and energy storage systems (ESS) have increased, the demand for secondary batteries as an energy source has increased as well. Accordingly, studies have been conducted on batteries which may meet various needs. Particularly, studies have been conducted on lithium secondary batteries as a power source, which has high energy density and excellent lifespan and cycle properties.

In general, depending on the material of a battery case, lithium secondary batteries are classified into can-type batteries, in which an electrode assembly is embedded in a cylindrical or prismatic metal can, or pouch-type batteries, in which an electrode assembly is embedded in a pouch-type case of aluminum laminate sheet. An electrode assembly is composed of a structure including a positive electrode, a negative electrode, and a separator interposed between the positive electrode and the negative electrode, and is a power generation device capable of charging and discharging. Here, the positive electrode may have a structure in which a positive electrode current collector and a positive electrode active material layer are sequentially stacked, and the negative electrode may have a structure in which a negative electrode current collector and a negative electrode active material layer are sequentially stacked. A foil made of an aluminum material may be generally used as the positive electrode current collector, and a foil made of a copper material may be generally used as the negative electrode current collector.

Typically, an evaluation of mechanical properties of an electrode current collector, such as strength and elongation, is conducted through destructive inspection, such as a tensile test. However, because of the destructive inspection, an electrode current collector on which the tensile test has performed cannot be used. In addition, it is difficult to accurately determine the mechanical properties of an electrode current collector since result values may vary depending on a sampling status or a skill level of a tester performing the evaluation.

### BRIEF SUMMARY

Aspects of the disclosure are directed to inspecting an electrode current collector and manufacturing an electrode with increased accuracy in evaluation of mechanical properties of the electrode current collector through non-destructive inspection. More specifically, through x-ray diffraction (XRD) analysis in selecting an electrode current collector, aspects of the disclosure allow for monitoring and/or screening mechanical properties of an electrode current collector with higher accuracy. Further, if evaluating the mechanical properties of an electrode current collector are included in the manufacturing process for the electrode, degradation in strength of the electrode current collector being heat-treated can be predicted and/or prevented, thereby resolving defects which may occur during electrode manufacturing.

An aspect of the disclosure provides for an apparatus for inspecting an electrode current collector, the apparatus including one or more processors configured to: perform x-ray diffraction (XRD) analysis on the electrode current collector to collect full-width-of-half-maximum data of a (hkl) plane; and select the electrode current collector based on a potential density difference (α) using the full-width-of-half-maximum data of the (hkl) plane.

In some examples, the electrode current collector is between a plurality of transfer rollers.

In some examples, the potential density difference (α) is defined by Equation 1:

$$α = \frac{\sqrt{\begin{matrix}{( \frac{A ( 111 ) - B ( 111 )}{A ( 111 )} )}^{2} + {( \frac{A ( 200 ) - B ( 200 )}{A ( 200 )} )}^{2} + \\ {( \frac{A ( 220 ) - B ( 220 )}{A ( 220 )} )}^{2} + {( \frac{A ( 311 ) - B ( 311 )}{A ( 311 )} )}^{2}\end{matrix}}}{4} \qquad [ Equation 1 ]$$

wherein A(hkl) is a full width of half maximum of a (hkl) plane of a reference electrode current collector, A(111)=0.089, A(200)=0.102, A(220)=0.113, and A(311)=0.138, and B(hkl) is a full-width-of-half-maximum of a (hkl) plane of an electrode current collector to be inspected.

In some examples, the one or more processors are further configured to select the electrode current collector having a potential density difference (α) of 0.20 or less.

In some examples, the one or more processors are further configured to select an electrode current collector having a potential density difference (α) of 0.18 or less.

In some examples, the electrode current collector includes a plurality of coating regions respectively coated with an electrode slurry composition and an uncoated portion between the plurality of coating regions, and the one or more processors are further configured to perform XRD analysis on the uncoated portion to collect the full-width-of-half-maximum data of the (hkl) plane.

In some examples, the selected electrode current collector has an ultimate tensile strength (UTS) of 20.0 kgf/mm² or greater.

In some examples, the selected electrode current collector has an elongation (EL) of 1.5% or greater.

In some examples, the selected electrode current collector has a crystal grain size of 0.70 μm or less.

In some examples, the electrode current collector is a positive electrode current collector.

Another aspect of the disclosure provides for an apparatus for manufacturing an electrode, the apparatus including: a roller-shaped unwinding part in which an electrode current collector is wound in one direction; a transfer part configured to transfer the electrode current collector; a coating part configured to apply and dry an electrode active material layer on at least one surface of the electrode current collector; and an inspection apparatus comprising one or more processors configured to: perform x-ray diffraction (XRD) analysis on the electrode current collector to collect full-width-of-half-maximum data of a (hkl) plane; and select the electrode current collector based on a potential density difference (α) using the full-width-of-half-maximum data of the (hkl) plane.

In some examples, the potential density difference (α) is defined by Equation 1:

$$α = \frac{\sqrt{\begin{matrix}{( \frac{A ( 111 ) - B ( 111 )}{A ( 111 )} )}^{2} + {( \frac{A ( 200 ) - B ( 200 )}{A ( 200 )} )}^{2} + \\ {( \frac{A ( 220 ) - B ( 220 )}{A ( 220 )} )}^{2} + {( \frac{A ( 311 ) - B ( 311 )}{A ( 311 )} )}^{2}\end{matrix}}}{4} \qquad [ Equation 1 ]$$

wherein A(hkl) is a full width of half maximum of a (hkl) plane of a reference electrode current collector, A(111)=0.089, A(200)=0.102, A(220)=0.113, and A(311)=0.138, and B(hkl) is a full-width-of-half-maximum of a (hkl) plane of an electrode current collector to be inspected.

In some examples, the one or more processors are further configured to select the electrode current collector having a potential density difference (α) of 0.20 or less.

In some examples, the coating part is further configured to heat-treat electrode current collector.

In some examples, the apparatus further includes a roll-pressing unit configured to press the electrode current collector between a pair of roll-pressing rolls.

In some examples, the apparatus further includes a winding unit configured to wind the selected electrode current collector into a rolled up form.

In some examples, the electrode current collector is a positive electrode current collector.

Yet another aspect of the disclosure provides for a method for manufacturing an electrode including: unwinding an electrode current collector in one direction; transferring the electrode current collector; applying and drying an electrode active material layer on at least one surface of the electrode current collector; and inspecting the electrode current collector by: performing, by one or more processors, x-ray diffraction (XRD) analysis on the electrode current collector to collect full-width-of-half-maximum data of a (hkl) plane; and selecting, by the one or more processors, the electrode current collector based on a potential density difference (α) using the full-width-of-half-maximum data of the (hkl) plane.

In some examples, the potential density difference (xx) is defined by Equation 1:

$$α = \frac{\sqrt{\begin{matrix}{( \frac{A ( 111 ) - B ( 111 )}{A ( 111 )} )}^{2} + {( \frac{A ( 200 ) - B ( 200 )}{A ( 200 )} )}^{2} + \\ {( \frac{A ( 220 ) - B ( 220 )}{A ( 220 )} )}^{2} + {( \frac{A ( 311 ) - B ( 311 )}{A ( 311 )} )}^{2}\end{matrix}}}{4} \qquad [ Equation 1 ]$$

wherein A(hkl) is a full width of half maximum of a (hkl) plane of a reference electrode current collector, A(111)=0.089, A(200)=0.102, A(220)=0.113, and A(311)=0.138, and B(hkl) is a full-width-of-half-maximum of a (hkl) plane of an electrode current collector to be inspected.

In some examples, the electrode current collector is selected based on having a potential density difference (α) of 0.20 or less.

### BRIEF DESCRIPTION OF THE DRAWINGS

FIG. 1 depicts a schematic view of an electrode manufacturing apparatus according to aspects of the disclosure.

FIG. 2 depicts an XRD graph of a reference positive electrode current collector according to aspects of the disclosure.

FIG. 3 depicts an XRD graph of a sample according to aspects of the disclosure.

FIG. 4 depicts a graph showing a relationship between a potential density difference (α) and a defect rate compared to a normal state according to aspects of the disclosure.

### DETAILED DESCRIPTION

The disclosure may be modified in various forms and have various examples, and specific examples thereof are shown by way of drawings and description below. It should be understood, however, that there is no intent to limit the disclosure to the specific examples, but on the contrary, the disclosure is to cover all modifications, equivalents, and alternatives falling within the spirit and technical scope of the disclosure. Like reference numerals refer to like elements throughout the description of the figures.

It will be understood that, although the terms such as first, second, A, B, and the like may be used herein to describe various elements, these elements should not be limited by these terms. These terms are only used to distinguish one element from another. For example, a first element could be termed a second element, and, similarly, a second element could be termed a first element, without departing from the scope of the disclosure. As used herein, the term “and/or” includes combinations of a plurality of associated listed items or any of the plurality of associated listed items.

The terms used herein are for the purpose of describing specific examples only and are not intended to limit the disclosure. As used herein, the singular forms “a”, “an” and “the” are intended to include the plural forms as well, unless the context clearly indicates otherwise. It will be further understood that the terms “comprises”, “comprising”, “includes”, “including” and/or “having”, when used herein, specify the presence of stated features, integers, steps, operations, constitutional elements, components and/or combinations thereof, but do not preclude the presence or addition of one or more other features, integers, steps, operations, constitutional elements, components, and/or combinations thereof.

### Electrode Current Collector Inspection Apparatus

An apparatus for inspecting an electrode current collector according to aspects of the disclosure may include a data collection unit and a selection unit. The data collection unit and the selection unit may include one or more processors and memory. The memory may include instructions that, when executed by the one or more processors, perform operations as described herein. The processors may include central processing units (CPUs), graphics processing units (GPUs), and/or application specific integrated circuits (ASICs), as examples. The memory may be a transitory or non-transitory computer readable medium. The memory may include random access memory (RAM), dynamic RAM (DRAM), static RAM (SRAM), read only memory (ROM), programmable ROM (PROM), electrically alterable ROM (EAROM), erasable PROM (EPROM), electrically erasable PROM (EEPROM), and/or flash memory, as examples.

The data collection unit may be on an electrode current collector between a plurality of transfer rollers for transferring or stopping the electrode current collector in a longitudinal direction. The data collection unit may be configured to perform XRD analysis on the electrode current collector in a stationary state to collect full-width-of-half-maximum data of a (hkl) plane. The selection unit may be configured to select an electrode current collector based on potential density difference (α) using the full-width-of-half-maximum data. For example, the selection unit may select an electrode current collector having a potential density difference (α) of 0.20 or less as defined by Equation 1.

$$α = \frac{\sqrt{\begin{matrix}{( \frac{A ( 111 ) - B ( 111 )}{A ( 111 )} )}^{2} + {( \frac{A ( 200 ) - B ( 200 )}{A ( 200 )} )}^{2} + \\ {( \frac{A ( 220 ) - B ( 220 )}{A ( 220 )} )}^{2} + {( \frac{A ( 311 ) - B ( 311 )}{A ( 311 )} )}^{2}\end{matrix}}}{4} \qquad [ Equation 1 ]$$

In Equation 1, A(hkl) is a full width of half maximum of a (hkl) plane of a reference electrode current collector, wherein A(111)=0.089, A(200)=0.102, A(220)=0.113, and A(311)=0.138, and B(hkl) is a full width of half maximum of a (hkl) plane of an electrode current collector to be inspected. Accordingly, by performing XRD analysis and selecting an electrode current collector based on potential density difference using full-width-of-half-maximum data, the mechanical properties of an electrode current collector can be evaluated with higher accuracy and in a non-destructive manner.

Since various heat-treatment processes are included in an electrode manufacturing process, the strength of an electrode current collector may gradually decrease as the electrode current collector undergoes each process, where the electrode current collector may be fractured due to tension during a roll-to-roll process. Particularly, if the strength of the uncoated portion of the electrode current collector is lowered, defects are highly likely to occur during electrode manufacturing, such as roll-pressing disconnection, tab disconnection, and/or tab folding. Accordingly, by performing XRD analysis and selecting an electrode current collector based on potential density difference using full-width-of-half-maximum data as part of the electrode manufacturing process, degradation in strength of an uncoated portion of the electrode current collector can be predicted and/or prevented, thereby resolving defects which may occur during the electrode manufacturing.

### (1) Data Collection Unit

The data collection unit may be on an electrode current collector between a plurality of transfer rollers for transferring or stopping the electrode current collector in a longitudinal direction, and may perform XRD analysis on the electrode current collector in a stationary state to collect full-width-of-half-maximum data of a (hkl) plane.

Specifically, the electrode current collector may include a plurality of coating regions respectively coated with an electrode slurry composition and an uncoated portion between the plurality of coating regions, where the data collection unit may perform XRD analysis on the uncoated portion to collect the full-width-of-half-maximum data of the (hkl) plane.

### (2) Selection Unit

The selection unit may select an electrode current collector by using the full-width-of-half-maximum data of the (hkl) plane collected by performing XRD analysis in the data collection unit. Specifically, the selection unit may select an electrode current collector based on a potential density difference. The selection unit may select an electrode current collector having a potential density difference less than a threshold potential density difference. For example, the selection unit may select an electrode current collector having a potential density difference (α) of 0.20 or less, 0.18 or less, and/or 0.01 to 0.18, as defined by Equation 1. An electrode current collector having the potential density difference (α) of greater than 0.20 may have problems in its mechanical properties thereof, and thus, may be more likely to be fractured during a roll-to-roll process. Therefore, the selection unit may not select an electrode current collector having a potential density difference (α) of greater than 0.20. The electrode current collector having such a potential density difference may be removed.

The selection unit may further select an electrode current collector based on an ultimate tensile strength (UTS) of the electrode current collector. For example, the selection unit may select an electrode current collector having a UTS of 20.0 kgf/mm² or greater, 20.0 kgf/mm² to 35.0 kgf/mm², and/or 25.0 kgf/mm² to 30.0 kgf/mm².

The selection unit may further select an electrode current collector based on an elongation (EL) of the electrode current collector. For example, the selection unit may select the electrode current collector having an EL of 1.5% or greater, 1.5% to 5.0%, and/or 1.6% to 3.0%.

The selection unit may further select an electrode current collector based on a crystal grain size of the electrode current collector. For example, the selection unit may select the electrode current collector having a crystal grain size of 0.70 μm or less, 0.01 μm to 0.70 μm, and/or 0.10 μm to 0.60 μm.

Selecting the electrode current collector based on the UTS, the EL, and/or the crystal grain size may reduce the risk of disconnection or other defects due to tension and roll force during a roll-to-roll process of an electrode or other processing of the electrode, particularly if the electrode current collector is a positive electrode current collector.

### Electrode Manufacturing Apparatus

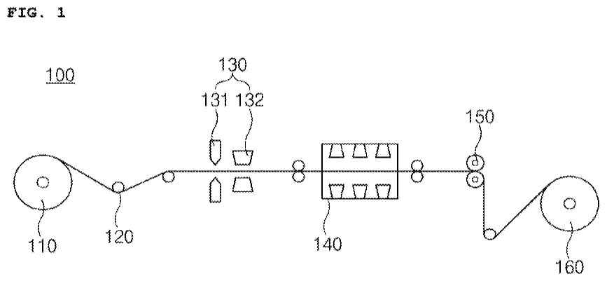

FIG. 1 is a schematic view for describing an electrode manufacturing apparatus according to aspects of the disclosure.

The electrode manufacturing apparatus 100 may include a roller-shaped unwinding part 110 in which an electrode current collector is wound in one direction, a transfer part 120 configured to continuously transfer the electrode current collector, a coating part 130 configured to apply and dry an electrode active material layer on at least one surface of the electrode current collector transferred from the unwinding part 110, and an inspection unit 140 including the electrode current collector inspection apparatus as described previously.

The unwinding part 110 may refer to a component for unwinding an electrode current collector wound in a rolled up form. Specifically, the unwinding part 110 may have a rolled up form, and the electrode current collector may be wound or unwound depending on a rotation direction. The unwinding part 110 may continuously feed the electrode current collector by unwinding the electrode current collector wound in a rolled up form.

The electrode current collector may have high conductivity without causing a chemical change in a battery, and for example, may include at least one of copper, stainless steel, aluminum, nickel, titanium, heat-treated carbon and/or an aluminum-cadmium alloy.

The electrode current collector may be used in various forms such as a film, a sheet, a foil, a net, a porous body, a foam, and/or a non-woven body, as examples. Further, the electrode current collector may have microscopic irregularities formed on its surface thereof to improve bonding strength of an active material and/or improve adhesive force of an electrode active material. The electrode current collector may have a thickness of 3 μm to 500 μm.

The electrode current collector may be a negative electrode current collector or a positive electrode current collector. If the electrode current collector is a negative electrode current collector, the negative electrode current collector may include a copper material. If the electrode current collector is a positive electrode current collector, the positive electrode current collector may include an aluminum material.

The transfer part 120 may receive an electrode current collector unwound from the unwinding part 110 and may transfer the electrode current collector to the coating part 130 and the inspection unit 140. Here, the transfer part may be a roll.

The coating part 130 may apply and dry an active material slurry on the surface of the electrode current collector to form an active material layer. The surface of the electrode current collector may include a plurality of coating regions respectively coated with the active material slurry, and between the plurality of coating regions, an uncoated portion in which the electrode current collector is exposed to the outside.

The coating part 130 may apply the active material slurry by any slurry application method, such as slit-die, gravure, doctor blade, silk screen, offset, spray, and/or dip. The coating part 130 may dry the active material slurry by any drying method involving forming an active material layer by evaporating a solvent from an active material slurry and not causing a chemical change to the active material slurry, such as a hot air method, a direct heating method, and/or an induction heating method. For example, the drying temperature may be 30° C. to 250° C., 40° C. to 200° C., and/or 50° C. to 170° C. For example, the drying time may be 10 seconds to 300 seconds, 20 seconds to 240 seconds, and/or 30 seconds to 180 seconds.

The active material slurry may include an active material and a solvent.

The active material may be any active material commonly used in the art, and may be a negative electrode active material or a positive electrode active material. The negative electrode active material may include a lithium metal, a carbon material capable of reversible intercalation/de-intercalation of lithium ions, a metal or an alloy of the metal and lithium, a metal composite oxide, a material capable of doping and undoping lithium, and/or a transition metal oxide, as examples. The positive electrode active material may be a compound capable of reversible intercalation and de-intercalation of lithium, and may include a lithium metal oxide including one or more metals, such as cobalt, manganese, nickel, and aluminum, and/or lithium, as examples. More specifically, the lithium metal oxide may include a lithium-manganese-based oxide, a lithium-cobalt-based oxide, a lithium-nickel-based oxide, a lithium-nickel-manganese-based oxide, a lithium-nickel-cobalt-based oxide, and a lithium-manganese-cobalt-based oxide, a lithium-nickel-manganese-cobalt-based oxide, and/or a lithium-nickel-cobalt-transition metal (M) oxide, as examples.

The solvent may be any solvent commonly used in the art, and may be an organic solvent or an aqueous solvent. The organic solvent may include dimethyl sulfoxide (DMSO), isopropyl alcohol, N-methylpyrrolidone (NMP), dimethyl formamide (DMF), and/or acetone, as examples. The aqueous solvent may be water (H₂O), as an example. The amount of solvent to be used may be sufficient for the solvent to dissolve or disperse the active material based on the application thickness and preparation yield of the slurry. The solvent may have a viscosity capable of exhibiting thickness uniformity when applied for subsequent electrode manufacturing.

The active material slurry may further include a conductive material and/or a binder.

The conductive material may impart conductivity to an electrode. The conductive material may include any conductive material having electron conductivity without causing a chemical change in a battery. For example, the conductive material may include graphite such as natural graphite or artificial graphite, a carbon-based material such as carbon black, acetylene black, Ketjen black, channel black, furnace black, lamp black, thermal black, and/or carbon fiber, metal powder or metal fiber such as copper, nickel, aluminum, and/or silver, a conductive tube such as a carbon nanotube, a conductive whisker such as a zinc oxide whisker and/or a potassium titanate whisker, a conductive metal oxide such as a titanium oxide, and/or a conductive polymer such as a polyphenylene derivative. As examples, the conductive material may be included in an amount of 0.01 wt % to 10 wt %, 0.1 wt % to 9 wt %, and/or 0.1 wt % to 5 wt % based on the total weight of the positive electrode active material layer.

The binder may improve the bonding between positive electrode active material particles and the adhesion between the positive electrode active material and the current collector. For example, the binder may include polyvinylidene fluoride (PVDF), a polyvinylidene fluoride-hexafluoropropylene copolymer (PVDF-co-HFP), polyvinyl alcohol, polyacrylonitrile, polymethylmethacrylate, carboxymethyl cellulose (CMC), starch, hydroxypropyl cellulose, regenerated cellulose, polyvinylpyrrolidone, polytetrafluoroethylene, polyethylene, polypropylene, an ethylene-propylene-diene monomer (EPDM), a sulfonated EPDM, styrene-butadiene rubber (SBR), fluorine rubber, a poly acrylic acid, a polymer having the hydrogen thereof substituted with Li, Na, and/or Ca, and/or various copolymers thereof. As examples, the binder may be included in an amount of 1 wt % to 30 wt %, 1 wt % to 20 wt %, and/or 1 wt % to 10 wt % based on the total weight of the positive electrode active material layer.

The inspection unit 140 includes the above-described electrode current collector inspection apparatus. Specifically, the inspection unit 140 may receive a heat-treated electrode current collector from the coating part 130 and select the electrode current collector. The inspection unit 140 may more accurately evaluate mechanical properties of an electrode current collector as an in-line process, thereby predicting in advance and preventing degradation in strength of the electrode current collector, so that it is possible to resolve defects which may occur during electrode manufacturing.

The electrode manufacturing apparatus 100 may further include a roll-pressing unit 150 for roll-pressing the electrode current collector on which the electrode active material layer is applied and dried and a winding unit 160 for winding the electrode current collector into a rolled up form. The roll-pressing unit 150 may press the electrode current collector coated with the active material layer between a pair of roll-pressing rolls to increase the density of the coating part. The winding unit 160 refers to a component for winding the electrode current collector coated with the active material layer into a rolled up form.

After the winding unit 160 winds the electrode current collector in a rolled up form, the electrode current collector may be stored or transferred for subsequent processes for manufacturing an electrode or a battery, e.g., roll-pressing of an active material layer, manufacturing of an electrode assembly, and/or activation.

### Electrode Manufacturing Method

Aspects of the disclosure include a method for manufacturing an electrode, the method including a process of inspecting an electrode current collector.

The method for manufacturing an electrode includes (S1) unwinding an electrode current collector in one direction and transferring the electrode current collector as it is being unwound, (S2) applying and drying an electrode active material layer on at least one surface of the electrode current collector, and (S3) inspecting the electrode current collector. The inspecting of the electrode current collector includes (a) stopping the transferring of the electrode current collector and performing XRD analysis on the electrode current collector to collect full-width-of-half-maximum data of a (hkl) plane, (b) selecting an electrode current collector based on a potential density difference (α) using the full-width-of-half-maximum data of the (hkl) plane, e.g., having a potential density difference (α) of 0.20 or less as defined by Equation 1, and (c) resuming the transferring of the electrode current collector. This method allows for monitoring or screening mechanical properties of the electrode current collector with higher accuracy and through non-destructive inspection during the electrode manufacturing. This method further allows for predicting and/or preventing degradation in strength of the electrode current collector being heat-treated, thereby resolving defects such as roll-pressing disconnection, tab disconnection, and tab folding, which may occur during the electrode manufacturing.

The method for manufacturing the electrode may further include (S4) roll-pressing the electrode current collector on which the electrode active material layer is applied and dried, and (S5) winding the roll-pressed electrode current collector into a rolled up form.

The roll-pressing may refer to increasing the density of an electrode active material layer by pressing an electrode current collector on which the electrode active material layer is applied and dried. The roll-pressing may be performed by a allowing the electrode current collector on which the electrode active material layer is formed to pass through a pair of roll-pressing rolls, thereby pressing the electrode current collector.

The winding may refer to obtaining the electrode current collector in a rolled up form. The electrode current collector wound in the roll up form may be stored or transferred for subsequent processes for manufacturing an electrode or a battery, e.g., roll-pressing of an active material layer, manufacturing of an electrode assembly, and/or activation.

### Experimental Example 1: XRD Analysis and Calculation of Potential Density Difference of Positive Electrode Current Collector

### (1) XRD Analysis of Positive Electrode Current Collector

Aluminum foil having a thickness of 15 μm was prepared as a reference positive electrode current collector, and four types of aluminum foils (Samples 1 to 4) having a thicknesses of 15 μm were prepared as positive electrode current collectors to be inspected. X-ray diffraction (XRD) analysis was performed on each of the aluminum foil samples. Here, the X-ray diffraction analysis was performed using an X-ray diffraction analyzer (Bruker AXS D4 Endeavor) at 25° C. under the following example conditions.
Source: Cu Target (A=1.5418 Å)
2θ: 20° to 120°
Step size: 0.02°/s
Total scan time: 150 min
Voltage: 40 kV
Current: 40 mA

Samples 1 to 4 are the reference positive electrode current collectors heat-treated under different conditions, wherein Sample 1 is the reference positive electrode current collectors heat-treated at 160° C. for 3 minutes, Sample 2 is the reference positive electrode current collectors heat-treated at 170° C. for 3 minutes, Sample 3 is the reference positive electrode current collectors heat-treated at 200° C. for 3 minutes, and Sample 4 is the reference positive electrode current collectors heat-treated at 230° C. for 3 minutes.

### (2) Calculation of Full-Width-of-Half-Maximum and Potential Density Difference (α) of Positive Electrode Current Collector

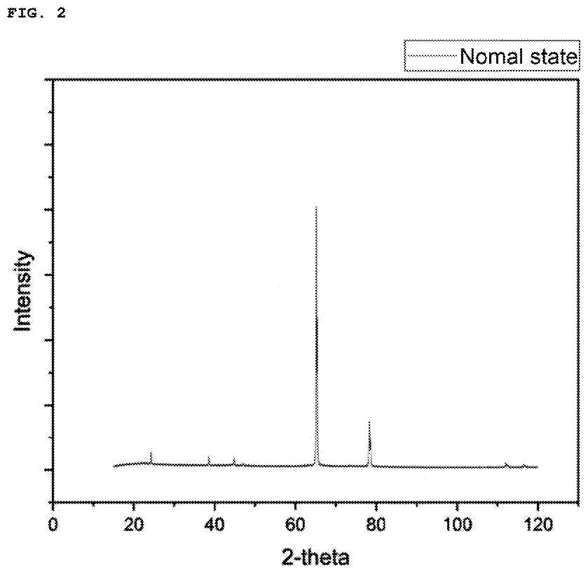

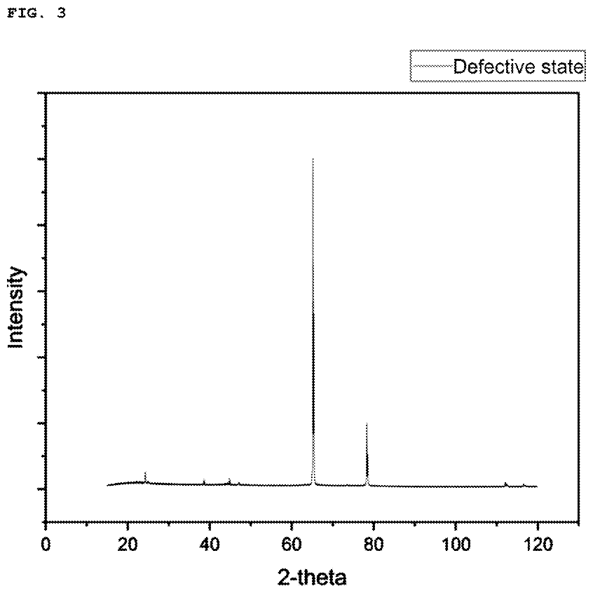

The full-width-of-half-maximum of each peak was measured for the aluminum foil of the reference positive electrode current collector and of each of the aluminum foil samples from XRD graphs obtained by the X-ray diffraction analysis, and then the potential density difference (α) defined by Equation 1 below was calculated. The results are shown in [Table 1] below, and the XRD graphs of the reference positive electrode current collector and Sample 4 are shown in FIG. 2 and FIG. 3, respectively.

TABLE 1

| | | | | | Potential |
|---|---|---|---|---|---|
| | XRD full width of half | | | | density |
| | maximum (FWHM) | | | | difference |
| | (111) | (200) | (220) | (311) | (α) |
| Reference | 0.089 | 0.102 | 0.113 | 0.138 | — |
| Sample 1 | 0.071 | 0.065 | 0.086 | 0.098 | 0.12 |
| Sample 2 | 0.061 | 0.065 | 0.071 | 0.087 | 0.18 |
| Sample 3 | 0.054 | 0.059 | 0.065 | 0.069 | 0.22 |
| Sample 4 | 0.045 | 0.057 | 0.062 | 0.065 | 0.24 |

### Experimental Example 2: Measurement of Mechanical Properties and Average Crystal Grain Size of Positive Electrode Current Collector

### (1) Mechanical Properties of Positive Electrode Current Collector

The ultimate tensile strength (UTS) and elongation (EL), which are mechanical properties of the aluminum foil of the reference positive electrode current collector and of each of Samples 1 to 4, which are the positive electrode current collectors to be inspected, were measured.

Specifically, the positive electrode current collector was punched to a size of 150 mm×12.7 mm. In this case, the direction of the punching was set to a direction (MD direction) parallel to a direction of electrode driving. The sample was fastened to upper/lower jigs of a universal testing machine (UTM), wherein the gauge length was set to 50 mm, and the measurement rate was set to 20 mm/min, and the UTS was measured by pulling the sample in an up-and-down direction until the sample was fractured.

Specifically, the aluminum foil of the reference positive electrode current collector and of each of Samples 1 to 4 was cut to a width of 12.7 mm. Both ends of the cut sample were fastened to the upper and lower jigs of the UTM, respectively, and then pulled in the up and down direction to measure the elongation of the positive electrode current collector. The measurement results are shown in [Table 2] below.

### (2) Average Crystal Grain Size of Positive Electrode Current Collector

The average crystal grain size of the aluminum foil of the reference positive electrode current collector and of each of Samples 1 to 4 was measured. Specifically, the average crystal grain size of a copper foil was measured by electron backscatter diffraction (EBSD) analysis. The measurement results are shown in [Table 2] below.

TABLE 2

| | Ultimate | | Average |
|---|---|---|---|
| | tensile | | crystal grain |
| | strength | Elongation | size |
| | [UTS, kgf/mm²] | [EL, %] | [μm] |
| Reference | 27.6 | 2.8 | Less than 0.1 |
| Sample 1 | 24.5 | 2.1 | 0.43 |
| Sample 2 | 21.2 | 1.9 | 0.52 |
| Sample 3 | 18.3 | 1.4 | 0.73 |
| Sample 4 | 17.3 | 1.3 | 0.75 |

Referring to [Table 1] and [Table 2], in the case of Samples 1 and 2 in which the calculated potential density difference (α) of the positive electrode current collector is 0.20 or less, it can be confirmed that the ultimate tensile strength of the positive electrode current collector is 20 kgf/mm² or greater and the elongation is 2.0% or greater. In addition, it can be confirmed that as the calculated potential density difference (α) of the positive electrode current collector increases and becomes greater than 0.20, mechanical properties, such as the ultimate tensile strength and the elongation, decrease significantly. In the case of a positive electrode current collector having an ultimate tensile strength of less than 20 kgf/mm² or an elongation of less than 2.0%, there is a higher possibility that an aluminum foil will be fractured during a roll-to-roll process of an electrode, so that the defect rate tends increase.

### (c) Relationship Between Potential Density Difference (α) and Defect Rate Compared to Normal State

Nine aluminum foils (Sample A) having a thickness of 15 μm, nine aluminum foils (Sample B) having a thickness of 15 μm, and an aluminum foil (Sample C) having a thickness of 15 μm were prepared in 50 sets of 10 pieces, respectively, and were heat-treated as shown in Table 3 below.

As described above, X-ray diffraction (XRD) analysis was performed on each aluminum foil to calculate a potential density difference (α) compared to a normal state, and an average value thereof was obtained.

TABLE 3

| Sample | Conditions of heat- | | | | |
|---|---|---|---|---|---|
| number | treatment | | Sample A | Sample B | Sample C |
| (5 sets | Temperature | Time | Average α | Average α | Average |
| each) | (° C.) | (minutes) | value | value | α value |
| 1 | 100 | 3 | 0.01 | 0.05 | 0.01 |
| 2 | 120 | 3 | 0.03 | 0.07 | 0.03 |
| 3 | 140 | 3 | 0.05 | 0.09 | 0.07 |
| 4 | 160 | 3 | 0.07 | 0.11 | 0.09 |
| 5 | 170 | 3 | 0.09 | 0.13 | 0.11 |
| 6 | 180 | 3 | 0.11 | 0.19 | 0.15 |
| 7 | 190 | 3 | 0.19 | 0.23 | 0.21 |
| 8 | 200 | 3 | 0.27 | 0.31 | 0.27 |
| 9 | 230 | 3 | 0.31 | — | — |

In addition, the ultimate tensile strength and the elongation were measured for the samples, and the ratio of positive electrode current collectors having an ultimate tensile strength of less than 20 kgf/mm² or having an elongation of less than 2.0% was obtained.

TABLE 4

| | Sample A | | Sample B | | Sample C | |
|---|---|---|---|---|---|---|
| Sample | | Defec- | | Defec- | | Defec- |
| number | | tive | | tive | | tive |
| (5 sets | Average | rate | Average | rate | Average | rate |
| each) | α value | (%) | α value | (%) | α value | (%) |
| 1 | 0.01 | 1 | 0.01 | 2 | 0.01 | 2 |
| 2 | 0.03 | 1 | 0.03 | 3 | 0.03 | 1 |
| 3 | 0.05 | 3 | 0.05 | 3 | 0.05 | 2 |
| 4 | 0.07 | 5 | 0.07 | 5 | 0.07 | 5 |
| 5 | 0.09 | 6 | 0.09 | 4 | 0.09 | 4 |
| 6 | 0.11 | 6 | 0.11 | 6 | 0.11 | 8 |
| 7 | 0.19 | 21 | 0.13 | 9 | 0.15 | 19 |
| 8 | 0.27 | 52 | 0.19 | 26 | 0.21 | 34 |
| 9 | 0.31 | 87 | — | — | 0.27 | 54 |

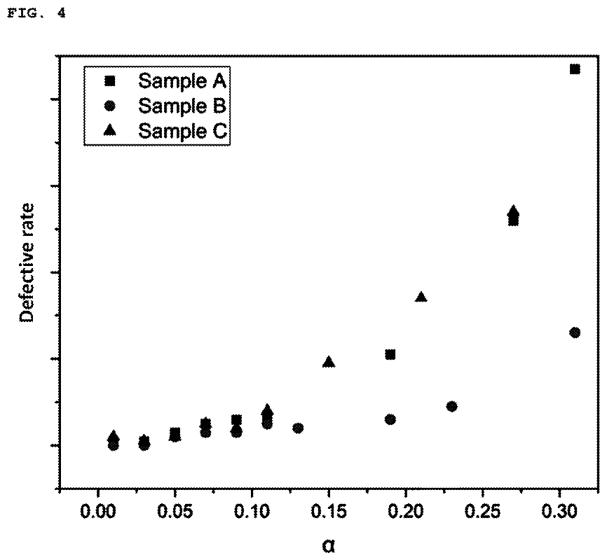

As can be confirmed from Table 4 and FIG. 4 above, the defect rate increases as the potential density difference (α) with respect to a normal state increases, and the defect rate further increases as the potential density difference (α) with respect to a normal state further increases.

Unless otherwise stated, the foregoing alternative examples are not mutually exclusive but may be implemented in various combinations to achieve unique advantages. As these and other variations and combinations of the features discussed above can be utilized without departing from the subject matter defined by the claims, the foregoing description of the examples should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible implementations. Further, the same reference numbers in different drawings can identify the same or similar elements.

1. An apparatus for inspecting an electrode current collector, the apparatus comprising:
a data collection unit, which is on an electrode current collector between a plurality of transfer rollers for transferring or stopping the electrode current collector in a longitudinal direction, and configured to perform XRD analysis on the electrode current collector in a stationary state to collect full-width-of-half-maximum data of a (hkl) plane; and
a selection unit configured to select an electrode current collector having a potential density difference (α) of 0.20 or less as defined by Equation 1 below by using the above data:
$$α = \frac{\sqrt{\begin{matrix}{( \frac{A ( 111 ) - B ( 111 )}{A ( 111 )} )}^{2} + {( \frac{A ( 200 ) - B ( 200 )}{A ( 200 )} )}^{2} + \\ {( \frac{A ( 220 ) - B ( 220 )}{A ( 220 )} )}^{2} + {( \frac{A ( 311 ) - B ( 311 )}{A ( 311 )} )}^{2}\end{matrix}}}{4} \qquad [ Equation 1 ]$$
wherein in Equation 1 above,
A(hkl) is a full width of half maximum of a (hkl) plane of a reference electrode current collector, wherein A(111)=0.089, A(200)=0.102, A(220)=0.113, and A(311)=0.138, and
B(hkl) is a full width of half maximum of a (hkl) plane of an electrode current collector to be inspected.

2. The apparatus of claim 1, wherein the selection unit is configured to select an electrode current collector having a potential density difference (α) of 0.18 or less.

3. The apparatus of claim 1, wherein:
the electrode current collector comprises a plurality of coating regions respectively coated with an electrode slurry composition, and an uncoated portion between the plurality of coating regions; and
the data collection unit is configured to perform XRD analysis on the uncoated portion to collect the full-width-of-half-maximum data of the (hkl) plane.

4. The apparatus of claim 1, wherein the electrode current collector selected by the selection unit has an ultimate tensile strength (UTS) of 20.0 kfg/mm² or greater.

5. The apparatus of claim 1, wherein the electrode current collector selected by the selection unit has an elongation (EL) of 1.5% or greater.

6. The apparatus of claim 1, wherein the electrode current collector selected by the selection unit has a crystal grain size of 0.70 μm or less.

7. The apparatus of claim 1, wherein the electrode current collector is a positive electrode current collector.

8. An apparatus for manufacturing an electrode, the apparatus comprising:
a roller-shaped unwinding part in which an electrode current collector is wound in one direction;
a transfer part configured to continuously transfer the electrode current collector;
a coating part configured to apply and dry an electrode active material layer on at least one surface of the electrode current collector; and
an inspection unit including the inspection apparatus of claim 1.

9. The apparatus of claim 8, wherein the electrode current collector heat-treated in the coating part is selected through the inspection unit.

10. The apparatus of claim 8, wherein the electrode current collector is a positive electrode current collector.

11. A method for manufacturing an electrode, the method comprising processes of:
(S1) unwinding and then continuously feeding and transferring a current collector from a roller-shaped unwinding part in which an electrode current collector is wound in one direction;
(S2) applying and drying an electrode active material layer on at least one surface of the electrode current collector; and
(S3) inspecting the electrode current collector,
wherein the process of inspecting of the electrode current collector includes steps of:
(a) stopping the electrode current collector being transferred, and performing XRD analysis on the electrode current collector to collect full-width-of-half-maximum data of a (hkl) plane;
(b) selecting an electrode current collector having a potential density difference (α) of 0.20 or less as defined by Equation 1 below by using the above data; and
(c) resuming transferring the electrode current collector:
$$α = \frac{\sqrt{\begin{matrix}{( \frac{A ( 111 ) - B ( 111 )}{A ( 111 )} )}^{2} + {( \frac{A ( 200 ) - B ( 200 )}{A ( 200 )} )}^{2} + \\ {( \frac{A ( 220 ) - B ( 220 )}{A ( 220 )} )}^{2} + {( \frac{A ( 311 ) - B ( 311 )}{A ( 311 )} )}^{2}\end{matrix}}}{4} \qquad [ Equation 1 ]$$
wherein in Equation 1 above,
A(hkl) is a full width of half maximum of a (hkl) plane of a reference electrode current collector, wherein A(111)=0.089, A(200)=0.102, A(220)=0.113, and A(311)=0.138, and
B(hkl) is a full width of half maximum of a (hkl) plane of an electrode current collector to be inspected.

12. The method of claim 11, further comprising (S4) a process of roll-pressing the electrode current collector on which the electrode active material layer is applied and dried; and (s5) a window process for winding the roll-pressed electrode current collector into a roll form.

13-20. (canceled)
